(19) United States
(12) Patent Application Publication
(10) Pub. No.: US 2003/0058124 A1
(43) Pub. Date: Mar. 27, 2003

(54) DECORATIVE ALERT SYSTEM

(75) Inventor: Chen-Fa Hsieh, Taipei Hsien (TW)

Correspondence Address: Knobbe Martens, Olson & Bear LLP, 2040 Main Street, 14th Floor, Irvine, CA, 92614, US, 949-760-0404, 949-760-9502

(73) Assignee: American Products Company, Inc., Corona, 92883 (US)

(21) Appl. No.: 09/605,282

(22) Filed: Jun. 28, 2000

(30) Foreign Application Priority Data
Oct. 26, 1999 (TW) 088218182

(51) Int. Cl. G08B 5/00

(52) U.S. Cl. 340/815.4

(57) ABSTRACT

### Abstract of Disclosure

A decorative alert system includes an alerting circuit arrangement disposed in a casing, which includes a central process circuit and a sparkling control circuit, wherein the alerting circuit arrangement electrically connected with a centrifugal sensor for controlling the alerting circuit arrangement by switching on and off of a power source. When a centrifugal force is applied on the alerting circuit arrangement, the alerting circuit arrangement is electrically connected with the power source, so as to electrically connect with the central process circuit and the sparkling control circuit. So, a plurality of illuminators controlled by the sparkling control circuit are lightened up for illuminating sparkling lights to signify as an alert signal. Thus, the power source of the alerting circuit arrangement is serially connected with a photo cell unit for switching the alerting circuit arrangement on and off respective to the environmental brightness wherein when the surrounding turns dark, the photo cell unit detects the reducing of brightness and switches on the alerting circuit arrangement in order to generate the sparkling lights. So, the decorative alert system of the present invention is capable of mounting on the spoke of the wheel of the bicycle or a valve of a tire of a vehicle in such a manner the sparkling lights on the rotating wheel of the vehicle provide an alert signal to the surrounding and put ornamental effect on the vehicle.

### Background of Invention

### Field of the Invention

The present invention relates to alert system, and more particularly to a decorative alert system adapted for illuminating sparkling lights when a centrifugal force is applied on the decorative alert system in order to provide an alert signal and an ornamental effect as well.

### Description of the Related Arts

Since bicycle, motorcycle, and automobile are the major ground transportations that most people drive everyday, the safety of driving is mostly concerned by the drivers. So, most drivers like to install some illuminating device for not only decorating their vehicles but also providing an alert signal to other drivers. For example, bikers may install a decorative reflector on the wheels of their bicycles in such a manner the light from other vehicles such as the head light in the surrounding will reflect on the reflector in order to signify the motion of the bicycle for providing an alert signal to other drivers. However, the light reflected from the reflector has a short wavelength, especially during dusk that the light becomes dull, the reflected light is not bright enough for indicating the alert signal, so as the bad ornamental effect.

Other improved illuminating device, such as a globe illuminator which can be automatically illuminated at dark, is commonly used on the wheels of the bicycle such that when riding the bicycle, the lightened globe illuminator will provide an alert signal to other drivers at the surrounding. However, after a period of time, the globe illuminator may merely diminish its light intensity, so as to decrease the efficiency of the alert signal. So, the driver must buy a new globe illuminator to replace the old one in order to accomplish the alerting purpose. Thus, the globe illuminator can hardly provide an ornamental effect for the vehicle since the globe illuminator is being lightened at all time instead of having a sparkling light which can put ornaments on the vehicle.

### Summary of Invention

A main object of the present invention is to provide a decorative alert system which comprises an alerting circuit arrangement disposed in a casing wherein the circuit arrangement, comprises a central process circuit and a sparkling control circuit, is electrically connected with a centrifugal sensor for controlling the alerting circuit arrangement by switching on and off of a power source. When a centrifugal force is applied on the alerting circuit arrangement, the alerting circuit arrangement is electrically connected with the power source, so as to electrically connect with the central process circuit and the sparkling control circuit. So, a plurality of illuminators controlled by the sparkling control circuit are lightened up for illuminating sparkling lights to signify as an alert signal. Thus, the power source of the alerting circuit arrangement is serially connected with a photo cell unit for switching the alerting circuit arrangement on and off respective to the environmental brightness wherein when the surrounding turns dark, the photo cell unit detects the reducing of brightness and switches on the alerting circuit arrangement in order to generate the sparkling lights. So, the decorative alert system of the present invention is capable of installing into an existing vehicle wherein the casing is adapted for mounting on the spoke of the wheel of the vehicle in such a manner the sparkling lights on the rotating wheel of the vehicle provide an alert signal to the surrounding and put ornamental effect on the vehicle.

### Brief Description of Drawings

Fig. 1 is a circuit diagram of a decorative alert system according to a first preferred embodiment of the present invention.

Fig. 2 is a block diagram of a central process circuit of the decorative alert system according to the above first preferred embodiment of the present invention.

Fig. 3 is block diagram of a sparkling control circuit of the decorative alert system according to the above first preferred embodiment of the present invention.

Fig. 4 is an electric diagram of a sparkling period of the decorative alert system according to the above first preferred embodiment of the present invention.

Fig. 5 is a perspective view of a centrifugal sensor of the decorative alert system according to the above first preferred embodiment of the present invention.

Fig. 6 is an exploded perspective view of the decorative alert system according to the above first preferred embodiment of the present invention, illustrating the decorative alert system adapted to be installed on a bicycle.

Fig. 7 is a perspective view of the decorative alert system installed into an existing bicycle according to the above first preferred embodiment of the present invention.

Fig. 8 is an exploded perspective view of the decorative alert system according to a second preferred embodiment of the present invention, illustrating the decorative alert system adapted to be installed on a motorcycle.

Fig. 9 is a perspective view of the decorative alert system installed into an existing motorcycle according to the above second preferred embodiment of the present invention.

### Detailed Description

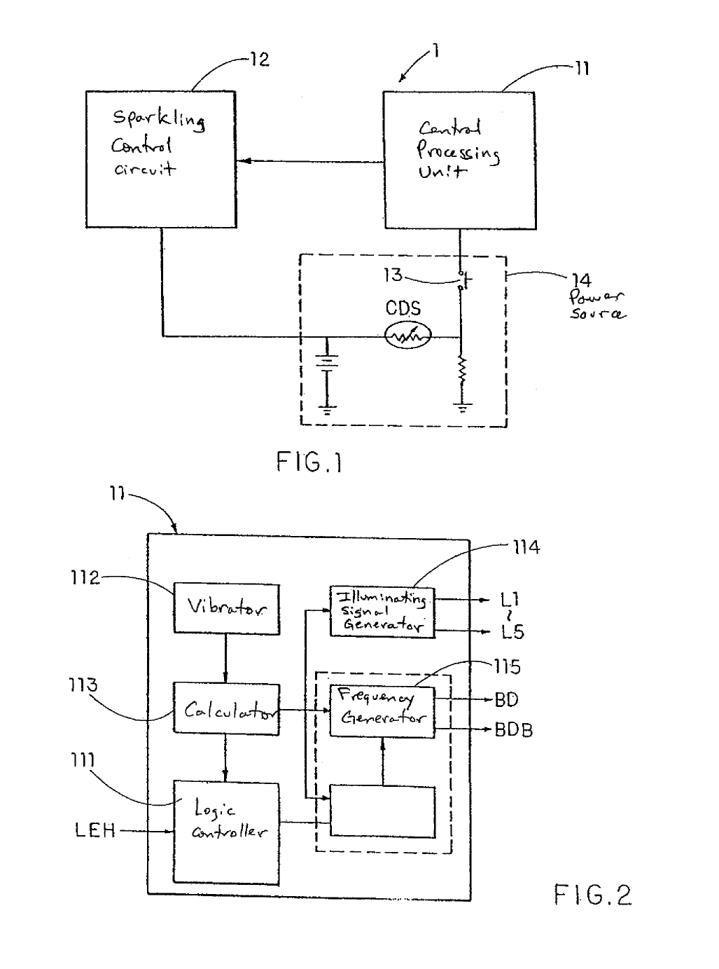

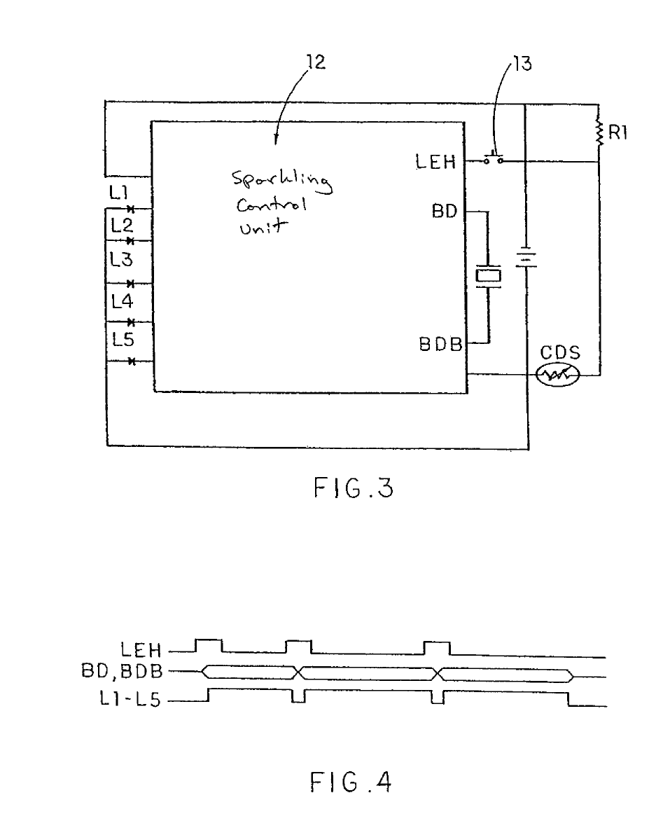

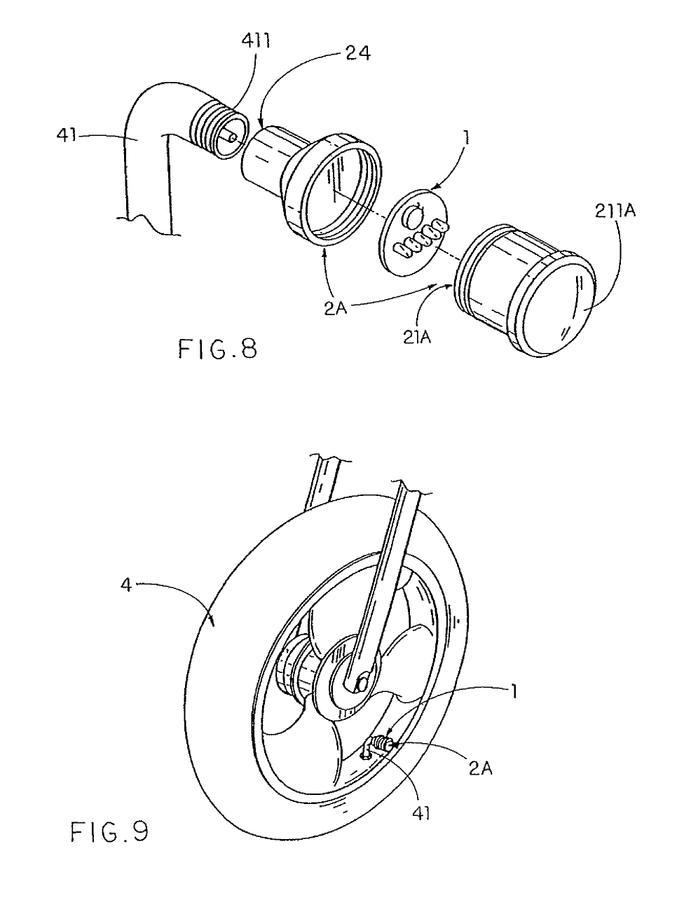

Referring to Figs. 1 to 7 of the drawings, a decorative alert system according to a first preferred embodiment of the present invention is illustrated. The decorative alert system comprises an alerting circuit arrangement 1 disposed in a casing 2, wherein the alerting circuit arrangement 1 comprises a central process circuit 11 and a sparkling control circuit 12. The alerting circuit arrangement 1 is electrically connected with a centrifugal sensor 13 for controlling the alerting circuit arrangement 1 by switching on and off of a power source 14. When a centrifugal force is applied on the alerting circuit arrangement 1, the alerting circuit arrangement 1 is electrically connected with the power source 14, so as to electrically connect with the central process circuit 11 and the sparkling control circuit 12. So, a plurality of illuminators L1, L2, L3, L4, and L5 controlled by the sparkling control circuit 12 are lightened up for illuminating sparkling lights to signify as an alert signal as well as for decoration. Thus, the power source 14 of the alerting circuit arrangement 1 is serially connected with a photo cell unit CDS for switching the alerting circuit arrangement 1 on and off respective to the environmental brightness wherein when the surrounding turns dark, the photo cell unit CDS detects the reducing of brightness and switches on the alerting circuit arrangement 1 in order to generate the sparkling lights for signifying as an alert signal as well as for decoration. Accordingly, the decorative alert system 1 of the present invention is capable of installing into an existing vehicle such as bicycle or motorcycle wherein the casing 2 is adapted for mounting on the spoke 31 of the wheel 3 of the bicycle or a valve 41 of a tire 4 of the motorcycle, as shown in Figs. 8 and 9, in such a manner the sparkling lights on the rotating wheel of the vehicle provide an alert signal to the surrounding and put ornamental effect on the vehicle.

Referring to Figs. 1, 2, and 3 of the drawings, the central process circuit 11 comprises a logic controller 111, a vibrator 112, and a calculator 113 wherein the logic controller 111, the vibrator 112, and the calculator 113 are electrically connected together as a serial connection. When the logic controller 111 receives a high position signal LED, the logic controller 111 will drive an illuminating signal generator 114 and a frequency generator 115 for respectively outputting signals to the sparkling control circuit 12. Then, the sparkling control circuit 12 is received the signal from the illuminating signal generator 114 or the signal from the frequency generator 115, the illuminators L1 to L5 will illuminate sparkling light to provide the alert signal and the ornamental effect or the frequency generator 115 will generate a woo sound respectively.

As shown in Fig. 4, the alerting circuit arrangement 1 is capable of randomly driving specific illuminators, for example L1, L2, L3, to illuminate the sparkling lights when the alerting circuit arrangement 1 is received the high position signal LEH at the first time. At the second time when the alerting circuit arrangement 1 is received the high position signal LEH, the alerting circuit arrangement 1 may drive all the illuminator L1 to L5 to illuminate the sparkling lights. In other words, various colors can be illuminated by the illuminators L1 to L5 and the pattern of sparkling lights is randomly selected from the alerting circuit arrangement 1 for providing the alert signal and the ornamental effect. Accordingly, the illuminators L1 to L5, preferably, are LEDs or other illuminating device.

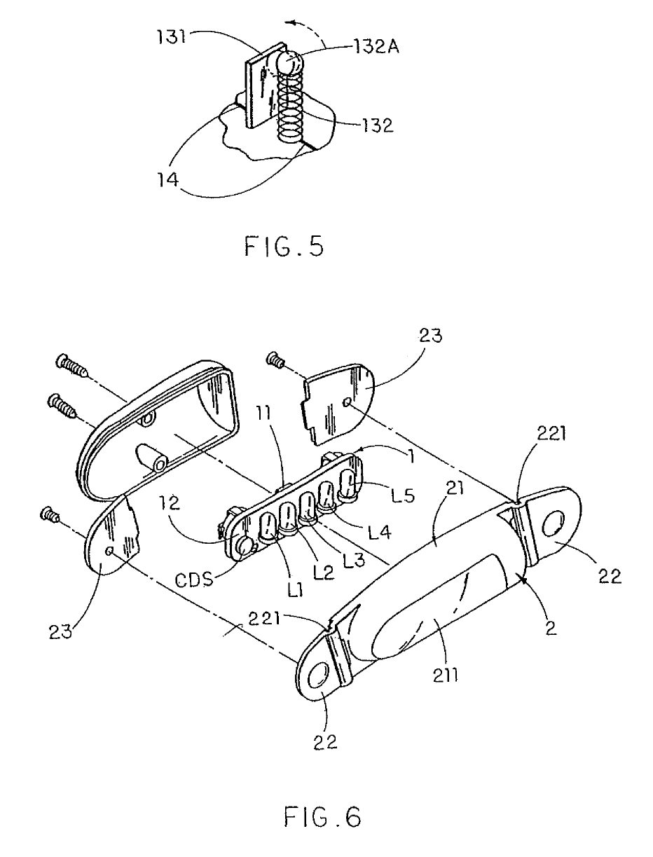

As shown in Fig. 5, the centrifugal sensor 13 comprises a conductive plate 131 and a resilient element 132 having a connector 132a mounted at a top end thereof, wherein the power source 14 is electrically connected to the conductive plate 131 and the resilient element 132 respectively in such an open circuit manner the connector 132a is normally disengage with the conductive plate 131. When the centrifugal sensor 13 detects a centrifugal force applied thereon, the centrifugal force will drive the connector 132a of the resilient 132 move toward the conductive plate 131 to connect therewith in such a manner the centrifugal sensor 13 is in a closed circuit manner for switching on the alerting circuit arrangement 1.

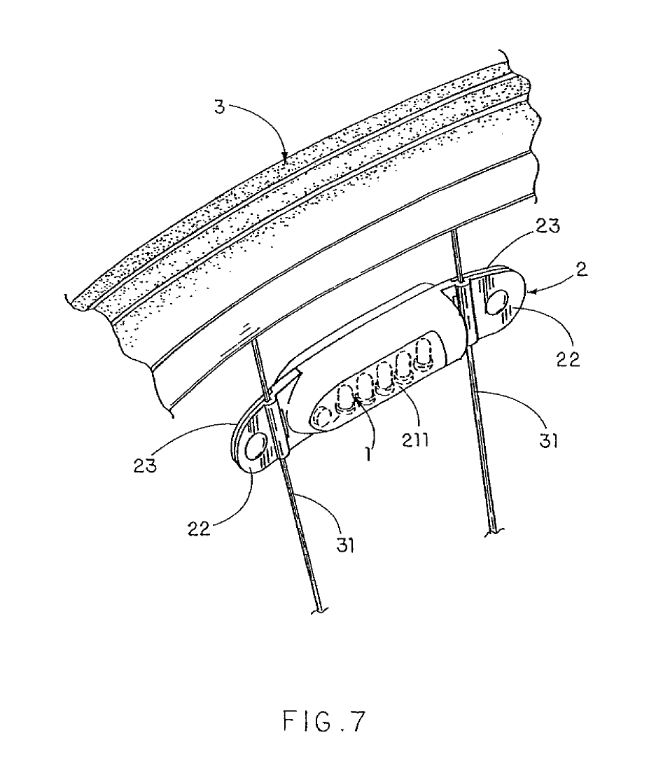

Referring to Figs. 6 and 7, the casing 2 adapted for mounting on a bicycle comprises a housing 21 having a transparent window 211 provided on an outer surface thereof wherein the alerting circuit arrangement 1 is disposed in the housing 21 such that the sparkling lights generated by the illuminators L1 to L2 adapted to pass through the transparent window 211 to outside, a pair of holding planes 22 extended from two sides of the housing 21 respectively wherein a mounting groove 221 is formed on each holding plane 22, and a pair of mounting planes 23 detachably mounted on the respective holding planes 22 for locking up the casing 2 on the spoke 31 of the wheel 3 of the bicycle. In other words, the casing 2 is adapted to mount on the spoke 31 of the wheel 3 of the bicycle wherein the spoke 31 is disposed in the mounting groove 22 and securely sandwiched between the holding plane 22 and the mounting plane 23 in such a manner the wheel 3 of the bicycle is arranged to drive the casing 2 to rotate to illuminate sparkling lights.

As shown in Figs. 8 and 9, the decorative alert system according to a second preferred embodiment of the present invention is illustrated, wherein the decorative alert system is capable of installing on the motorcycle. The casing 2a merely comprises a housing 21a having a transparent window 211a provided on an outer surface thereof wherein the alerting circuit arrangement 1 is disposed in the housing 21a such that the sparkling lights generated by the illuminators L1 to L2 adapted to pass through the transparent window 211a to outside, and a mounting cap 24 having an inner threaded portion mounted on a bottom of the housing 21a for screwing with an outer threaded portion 411 of the valve 41 of the tire 4 of the motorcycle, so as to securely mount the casing 2a on the motorcycle and drive the alerting circuit arrangement 1 to rotate to illuminate sparkling lights.

Accordingly, the alerting circuit arrangement 1 can be automatically switched on and off by the centrifugal sensor 13 or the photo cell unit CDS in such a manner the present invention does not need to switch on manually. When riding a bicycle or driving a motorcycle or a vehicle at a dull place or at night, the alerting circuit arrangement 1 will be automatically switched on wherein the illuminators L1 to L5 will continuously generate sparkling lights for signifying an alert signal to other people at the surrounding. So, the present invention is a safety apparatus for driving especially at night and the installation is simple and easy so that the user is able to install the decorative alert system by himself or herself.

While the foregoing description and diagram describe the preferred embodiments of the present invention, it should be appreciated that certain obvious modifications, variations, and substitutions may be made without departing from the spirit and scope of the present invention.

Claims

1. 6. (New) A motion activated light for a vehicle wheel having an air valve stem, said light comprising:
a connector complementary to the air valve stem for connecting said light thereto;
a power source connected in an electrical circuit;
a light source connected to said power source through the electrical circuit; and
a switch connected to the electrical circuit, said switch responsive to movement of the wheel to thereby energize the light source.

2. 7. (New) The light of claim 6, wherein an inner tube comprises the air valve stem.

3. 8. (New) The light of claim 6, wherein the air valve stem has threads and the connector comprises complementary threads for connecting said light to the air valve stem.

4. 9. (New) The light of claim 6, wherein said power source comprises a battery.

5. 10. (New) The light of claim 6, wherein said light source comprises a light emitting diode.

6. 11. (New) The light of claim 6, wherein said motion comprises a centrifugal force.

7. 12. (New) A motion activated light for a vehicle wheel having an air valve with a threaded stem, said light comprising:
a housing having threads complementary to the threaded stem for connecting said light to the air valve stem;
a power source connected to an electrical circuit;
a light emitting diode connected to the electrical circuit; and
a switch connected to close the electrical circuit responsive to movement of the wheel so as to energize the light emitting diode.

8. 13. (New) The light of claim 12, wherein an inner tube comprises the air valve stem.

9. 14. (New) The light of claim 12, wherein said motion activated light comprises at least one color.

10. 15. (New) The light of claim 12, wherein said housing comprises a substantially waterproof enclosure.

11. 16. (New) The light of claim 12, wherein said housing further comprises an ornamental shape.

12. 17. (New) The light of claim 12, wherein said light emitting diode emits light of a predetermined color.

13. 18. (New) The light of claim 12, wherein said motion sensitive switch intermittently closes said electrical circuit responsive to movement to thereby cause said light emitting diode to emit flashes of light.

14. 19. (New) The light of claim 12, wherein said motion sensitive switch energizes said light source for a predetermined time following movement of the wheel.

15. 20. (New) A lighted wheel for a vehicle, comprising:
a pneumatic tire comprising an air valve having a stem; and
a motion activated light connected to the air valve stem;
wherein the motion activated light comprises an electrical circuit having a power source, a light source, and a switch sensitive to motion of the wheel and connected to close the circuit to thereby energize the light source responsive to motion of the wheel.

16. 21. (New) The lighted wheel of claim 20, wherein the motion activated light further comprises a housing having a connector complementary to the air valve stem.

17. 22. (New) The lighted wheel of claim 20, wherein the motion activated light further comprises an ornamental shape.

18. 23. (New) The lighted wheel of claim 20, wherein said power source comprises at least one battery.

19. 24. (New) The lighted wheel of claim 20, wherein said light source comprises a light emitting diode.

20. 25. (New) The lighted wheel of claim 20, wherein said motion activated light comprises a color.

21. 26. (New) The lighted wheel of claim 20, wherein said motion sensitive switch intermittently energizes said light source responsive to motion to thereby cause said light source to emit flashes of light.

22. 27. (New) The lighted wheel of claim 20, wherein said motion sensitive switch energizes said light source for a predetermined time following movement of the wheel.

23. 28. (New) A method of lighting a vehicle wheel having an air valve stem, the method comprising:
connecting a light source to the air valve stem of the wheel, said light source activated by sufficient wheel motion; and
emitting light by causing the wheel to move sufficiently to activate the light source.

24. 29. (New) The method of claim 28, wherein the air valve stem comprises threads, the motion activated light comprises complementary threads, and connecting comprises screwing the motion activated light onto the air valve stem.

25. 30. (New) The method of claim 28, wherein causing the wheel to move comprises driving a vehicle having the lighted wheel attached thereto.

26. 31. (New) The method of claim 28, wherein emitting light comprises emitting light having a predetermined color.

27. 32. (New) A method of forming a visually perceptible light image adjacent a rotating wheel on a moving vehicle, the wheel having an air valve stem, comprising:
connecting a light to the air valve stem of the wheel, the light capable of being activated by sufficient wheel rotation and comprising a predetermined shape for forming the light image; and
causing the vehicle to move so as to impart sufficient rotation to the wheel to activate the light source to emit light, thereby forming the visually perceptible light image.

28. 33. (New) The method of claim 32, wherein the motion activated light comprises an electrical circuit having a power source, a light source, and a motion sensitive switch connected to close the circuit to thereby energize the light source responsive to motion of the wheel.

29. 34. (New) The method of claim 32, wherein the wheel comprises an inner tube having the air valve stem.

30. 35. (New) The method of claim 32, wherein the motion activated light comprises a light emitting diode.

31. 36. (New) The method of claim 32, further comprising emitting light having a color.
